(19) United States
(12) Patent Application Publication
(10) Pub. No.: US 2023/0135989 A1
(43) Pub. Date: May 4, 2023

(54) MANUFACTURING METHODS AND RELATED STRUCTURES, FOR EXAMPLE USEFUL IN AIRFRAMES AND OTHER STRUCTURES

(71) Applicant: IMAGINE AERO INC., Bellevue, WA (US)

(72) Inventor: Kevin Halverson, Twin Falls, ID (US)

(21) Appl. No.: 17/862,691

(22) Filed: Jul. 12, 2022

Related U.S. Application Data
(60) Provisional application No. 63/220,696, filed on Jul. 12, 2021.

(51) Int. Cl. B29C 44/12; B29B 11/10; B29C 44/42

(52) U.S. Cl. CPC B29C 44/1228; B29B 11/10; B29C 44/42; B29K 2705/00

(57) ABSTRACT

A method of manufacturing includes assembling two or more parts (e.g., non-extrusions) or extrusions (e.g., metal extrusions or plastic extrusions) into an assembly; placing the assembly into a mold; injecting a core material (e.g., expandable foam) into an interior or cavity of the assembly while the assembly is retained in the mold; and removing a resulting structure from the mold. The parts or extrusions may be treated before injecting the core material. The core material may be hardened or cured. The parts or extrusions may include a skin portion and integral reinforcement structures or stiffeners, integral complementary joint portions or features to fasten one another together, and/or retainers or structural features shaped and positioned to capture and/or hold onto core.

### FIELD OF THE DISCLOSURE

The present application generally relates to manufacturing methods and related structures which can be used in a large variety of applications, for example in a cost-effective manufacture and/or assembly of airframes or other structures, and in particular relates to manufacture and structures formed from assemblies of parts, for instance extruded parts, with a polymer or other lightweight (e.g., open cell or closed cell foam) core.

### BACKGROUND

### Description of the Related Art

There are various approaches currently employed in the manufacture and/or assembly of airframes and other structures.

One approach employs stamped sheet metal. Such typically requires a very large number of fasteners to physically couple various elements together. For example, a metal skin of a wing may be physically coupled by a large number of fasteners to ribs, spars and/or stringers or other underlying frame structures of the wing. Also for example, a skin of a fuselage (e.g., monocoque fuselage) may be physically coupled by a large number of fasteners to stringers or other underlying frame structure (e.g., frame) of the fuselage. These fasteners are typically installed by drilling a large numbers of holes in the sheet metal, than individually manually fixing a fastener in each hole, for example using a pneumatic puller. The cost of labor, as well as the cost the large number of fasteners and associated fixtures that are typically required for a given assembly adds significantly to the overall cost of manufacture.

Another approach employs manufacture of a shaped foam core. Such may employ post-shaping of a foam layup after application of composites. The resulting rough and unfinished surfaces require considerable time and labor to produce an acceptable finished surface.

Yet another approach employs mandrel wound composites. In such an approach, composite (e.g., pre-preg or fiberglass reinforced polymer matrix, for instance an epoxy or phenolic resin) is wound around a mandrel, and is typically cured in a large autoclave. The tooling involved in this approach can be complicated and/or costly and can require lengthy periods for design and procurement. The cycle time required for completion of finished structures using this approach preclude high volume production and is generally not well suited for mass production.

Another possible approach is additive manufacturing (e.g., three-dimensional (3D) printing). Additive manufacturing is not particularly suitable for manufacture of large structures, for instance structures typically associated with airframes (e.g., wing skins, fuselage skins). Additive manufacturing also typically suffers from high material costs, rendering such uneconomically and not particularly suited to mass production.

### BRIEF SUMMARY

Described herein are unique manufacturing methods or processes and resulting structures that allow for the low cost production for finished goods, with minimal added labor. The cost of production may, for example, approach the cost of the raw materials. The described manufacturing methods or processes can, for example, advantageously avoid subtraction of material typically associated with stamping, machining or other removal techniques. The described manufacturing methods or processes can, for example, advantageously allow for the selection of a large range of physical characteristics, while advantageously employing long established materials (e.g., aluminum alloys such as 2024-T3, 6061-T6, 3003-H14, 7075-T6 and/or 5052-H32 aluminum alloys; titanium).

The described manufacturing methods or processes and resulting structures can, for example, include joining a number of parts (e.g., metal extrusions, plastic extrusions, other types of extrusions, non-extruded parts) in an assembly and a providing a polymer or other lightweight (e.g., open cell foam or closed cell foam) core in an interior of the assembly, for example as the assembly is held in a mold (e.g., injection molding). For example, one or more parts can be extruded. Also for example, one or more parts can be non-extruded, for instance rolled, stamped, bent and/or machined. The extrusions can, for example, be metal extrusions, plastic extrusions, a combination of metal and plastic extrusions, or other types of extrusions or combinations of various different types of extruded materials. For example, the parts or extrusions may each include respective portions of a skin with one or more integral or monolithic reinforcement structures or stiffeners (e.g., stringers, spars). The parts or extrusions may, for example, each include one or more joint features which matingly couple to complementary joint features on neighboring parts or extrusions in the structure (e.g., airframe structure). The joint features may, for example, lock neighboring parts or extrusions together. The parts may be assembled, for example via the joint features, to form an assembly. The assembly can, for example, be a partially closed structure, for example having a continuous or closed surface when viewed in profile, although the assembly may be open at one or both ends thereof. One or more main stiffeners or other support member can optionally be added to the assembly, for example one or more main spars or frames. The resulting structure can be located in a mold (e.g., between two or more portions of a mold) and a core material (e.g., polymer or other lightweight core material for instance an open cell or closed cell foam) injected or otherwise provided into a cavity. The core material (e.g., open cell or closed cell foam) may expand, forcing the skins of the parts or extrusions against an inner surface of the mold, providing precise alignment of each individual part or extrusion that forms the assembled structure. The external surface of the resulting structure being a fairly precise analog of the inside of the mold. The parts or extrusions may include one or more capture features that cause the expanding polymer or foam to become entrapped such that the assembled parts or extrusions and the polymer or expanded foam form a unitary or monolithic structure that cannot be separated without destruction of a least a portion of that structure.

The near raw material cost for extrusion is the lowest practical manufacturing approach for metals, for instance metal alloys typically used in aviation, and provide know characteristics using long established materials. The parts or extrusions can be pre-finished, for example via anodizing, painting, power painting, powder coated, prior to being assembled into the assembly or molded into a finished structure, advantageously further reducing labor costs and time. Internal structures, for example conduits for transportation or containment of fluids, are readily manufactured using the same or similar techniques as described herein. Similarly, structures which can be used for electrical wiring, hydraulics, actuators (e.g., push rods, control cables) along with various other types of structures can be readily manufactured using the same or similar techniques as described herein.

The described manufacturing methods or processes and resulting structures can, for example, be particularly useful for aircraft and airframes, and can, for instance, be used to manufacture relative large structures (e.g., wings, vertical stabilizers, horizontal stabilizers, other airfoils, fuselages and empennages), control surfaces (e.g., rudder, ailerons, flaps, slats, spoilers, trim tabs), and/or internal structures (e.g., load bearing floors, conduits for fluids, conduits for control cables, power lines, electrical wiring). The described manufacturing methods or processes and resulting structures can, for example, be particularly usefully applied to various other structures, for example surface and subsurface watercraft, surface vessels or vehicles, storage containers, intermodal shipping containers, enclosures, buildings, and a multitude of other fabricated structures.

### BRIEF DESCRIPTION OF THE SEVERAL VIEWS OF THE DRAWINGS

FIG. 1 is a side isometric view of a part or extrusion in the form of a leading edge extrusion according to at least one illustrated implementation.

FIG. 2 is an isometric view of a part or extrusion being extruded from an extruder according to at least one illustrated implementation.

FIG. 3 is a side isometric view of two parts or extrusions joined together via complementary joint portions or features to form a portion of an assembly according to at least one illustrated implementation, the parts or extrusions including a leading edge extrusion and a lower leading edge skin extrusion.

FIG. 4 is an enlarged side isometric view of the two parts or extrusions joined together via complementary joints of FIG. 3 to better illustrate the complementary joint portions or features thereof.

FIG. 5 is a side isometric view of three parts or extrusions joined together via complementary joint portions or features to form a portion of an assembly according to at least one illustrated implementation, the parts or extrusions including a leading edge extrusion, a lower leading edge skin extrusion, and an upper leading edge skin extrusion.

FIG. 6 is a side isometric view of four parts or extrusions joined together via complementary joint portions or features to form a portion of an assembly according to at least one illustrated implementation, the parts or extrusions including a leading edge extrusion, a lower leading edge skin extrusion, an upper leading edge skin extrusion, and a lower trailing edge skin extrusion.

FIG. 7 is a side isometric view of five parts or extrusions joined together via complementary joint portions or features to form an assembly according to at least one illustrated implementation, the parts or extrusions including a leading edge extrusion, a lower leading edge skin extrusion, an upper leading edge skin extrusion, a lower trailing edge skin extrusion, and an upper trailing edge skin extrusion.

FIG. 8 is a side isometric view of six parts or extrusions joined together via complementary joint portions or features to form an assembly according to at least one illustrated implementation, the parts or extrusions including a leading edge extrusion, a lower leading edge skin extrusion, an upper leading edge skin extrusion, a lower trailing edge skin extrusion, an upper trailing edge skin extrusion, and a trailing edge skin extrusion.

FIG. 9 is a side isometric view of the assembly of FIG. 8 with a main support structure added, in the form of a main spar, according to at least one illustrated implementation.

FIG. 10 is a top, side isometric view of the assembled structure of FIG. 9 with the main spar extending outwardly from an interior of the assembly of FIG. 8, according to at least one illustrated implementation.

FIG. 11 is a top, side isometric view of a mold according to at least one illustrated implementation, which can be employed in manufacturing a finished structure comprising one or more parts or extrusions, for example employing the assembled structure of FIGS. 9 and 10.

FIG. 12 is a top, side isometric view of the mold of FIG. 11 with the assembled structure of FIG. 10 inserted or received in a cavity of the mold, according to at least one illustrated implementation.

FIG. 13 is an isometric view of an injection system operable to inject core material into the cavity of the mold of FIG. 11 and into an interior of the assembled structure of FIG. 10 while the assembled structure is received in the cavity of the mold, according to at least one illustrated implementation.

FIG. 14 is a top, side isometric view of the mold of FIG. 11 with the assembled structure of FIG. 10 received in a cavity of the mold and a core injected into the interior of the assembled structure of FIG. 10, according to at least one illustrated implementation.

FIG. 15 is a top, side isometric view of a resulting or finished structure removed from the mold of FIG. 11, comprising the assembly of FIG. 8 with the main spar and the core, according to at least one illustrated implementation.

FIG. 16 is a flow diagram of a method of manufacture, according to at least one illustrated implementation.

### DETAILED DESCRIPTION

In the following description, certain specific details are set forth in order to provide a thorough understanding of various disclosed embodiments. However, one skilled in the relevant art will recognize that implementations and embodiments may be practiced without one or more of these specific details, or with other methods, components, materials, etc. In other instances, certain structures associated with extrusion, co-extrusion, molding, injection molding and various extrusions, assemblies, and/or structures have not been shown or described in detail to avoid unnecessarily obscuring descriptions of the various implementations and embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one implementation” or “an implementation” or “one embodiment” or “an embodiment” means that a particular feature, structure or characteristic described in connection with the embodiment is included in at least one implementation or at least one embodiment. Thus, the appearances of the phrases “one implementation” or “an implementation” or “in one embodiment” or “in an embodiment” in various places throughout this specification are not necessarily all referring to the same implementation or the same embodiment. Furthermore, the particular features, structures, or characteristics may be combined in any suitable manner in one or more implementations or in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the implementations or embodiments.

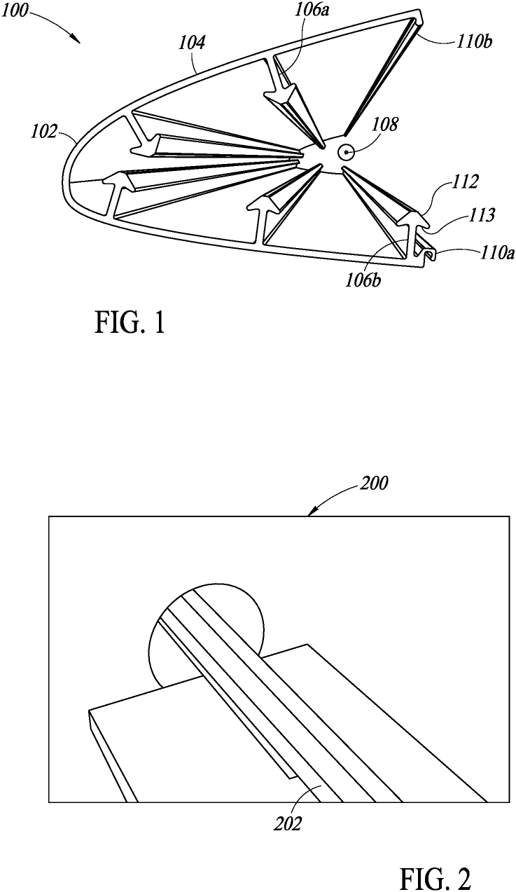

FIG. 1 shows a portion 100 of an assembly as one part or extrusion in the form of a leading edge extrusion 102, according to at least one illustrated implementation. The leading edge extrusion 102 includes a skin 104 and a plurality of reinforcement structures or stiffeners, for example in the form of stringers 106a, 106b (only two called out). The skin 104 typically provides a closed surface between a set of perimeter edges. The stringers 106a, 106b may extend along a length or longest dimension of the leading edge extrusion 102, and arrayed about a primary axis 108. The leading edge extrusion 102 can, for example, form a leading edge of an airfoil.

The leading edge extrusion 102 include one or more complementary joint portions or features 110a, 110b. The complementary joint portions or features 110a, 110b allow the leading edge extrusion 102 to be physically coupled or joined to one or more other parts or extrusions, as described below.

The leading edge extrusion 102 can include one or more retainers or structural features 112 (five shown, only one called out in FIG. 1) that are shaped and position to capture and/or hold onto a core (e.g., polymer, open cell or closed cell foam) when inserted and/or expanded and/or cured. The retainers or structural features 112 can, for example, take the form of a head or widen area with a capture region 113, for example formed at a distal end of the stringers 106a, 106b. The retainers or structural features 112 can, for example, resemble arrowheads, and be positioned at the end of the retainers or structural features 112 which resemble shafts of arrows. Notable, each retainers or structural features 112 can, for example, have a recess (e.g., where arrowhead interfaces to shaft). The retainers or structural features 112 can, for example, be distributed to be in direct opposition or in partial opposition to one another. The skin 104 and the retainers or structural features 112 can, for example, are advantageously an integral, monolithic structure formed via extrusion.

The parts of an assembly can include one or more metal parts, plastic parts, composite parts, or parts formed of materials other than or in addition to metal and/or plastic. Where the part is flat or has a relatively simple geometry, it may be advantageous for the part to be formed via any variety of manufacturing operations, for example stamping, rolling, bending, and/or machining. Where the part has a relatively complex geometry or profile, an extrusion may be preferred. Extrusions can take the form of metal extrusions, plastic extrusions or combinations of metal and plastic extrusions, or even extrusions of other materials or other combinations of materials. While some implementations are described with respect to an assembly of extrusions or even metal extrusions, such is not intended to be limiting unless expressly recited as extrusions or even metal extrusions in the claims.

FIG. 2 shows an extruder 200 extruding a part or extrusion 202, according to at least one illustrated implementation. The extruder 200 may take the form of an extruder or co-extruder that is operable to extrude materials (also referred to herein as core material) such as metals and/or polymers in a specified shape.

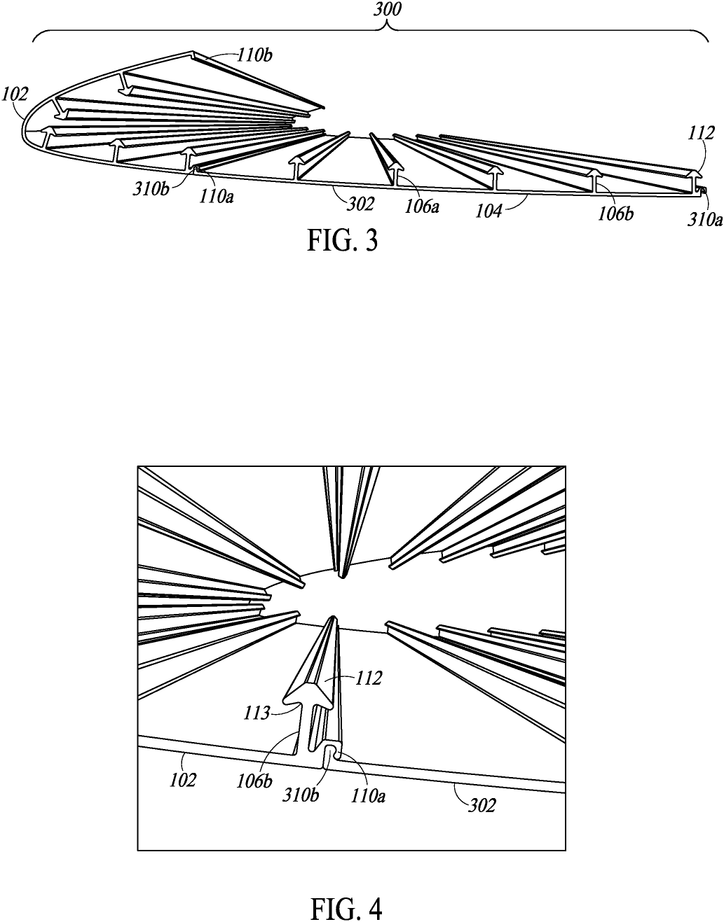

FIG. 3 shows a portion 300 of an assembly of two parts or extrusions in the form of the leading edge extrusion 102 (FIG. 1) and a lower leading edge skin extrusion 302, according to at least one illustrated implementation. The lower leading edge skin extrusion 302 includes a skin 104 and a plurality of reinforcement structures or stiffeners, for example in the form of stringers 106a, 106b (only two called out). The leading edge extrusion 102 and the lower leading edge skin extrusion 302 each include complementary joint portions or features 110a, 110b, 310a, 310b. The complementary joint portions or features 110a, 110b, 310a, 310b physically coupled or join the leading edge extrusion 102 and the lower leading edge skin extrusion 302 together at joints to form the portion of the assembly 300. The complementary joint portions or features 110a 110b, 310a, 310b can take the form of locking joint portions or features with lock together when physically engaged with one another.

The lower leading edge skin extrusion 302 can include one or more retainers or structural features 112 (only one called out in FIG. 3) that are shaped and position to capture and/or hold onto a core (e.g., polymer, open cell or closed cell foam) when inserted and/or expanded and/or cured. The retainers or structural features 312 can, for example, take the form of a head or widen area, for example formed at a distal end of the stringers 106a, 106b.

FIG. 4 shows an enlarged view of the leading edge extrusion 102 and the lower leading edge skin extrusion 302 joined together via the joints formed by joint portions or features 110a, 110b, 310a, 310b of FIG. 3, better illustrating the complementary joint portions or features 110a, 110b, 310a, 310b thereof.

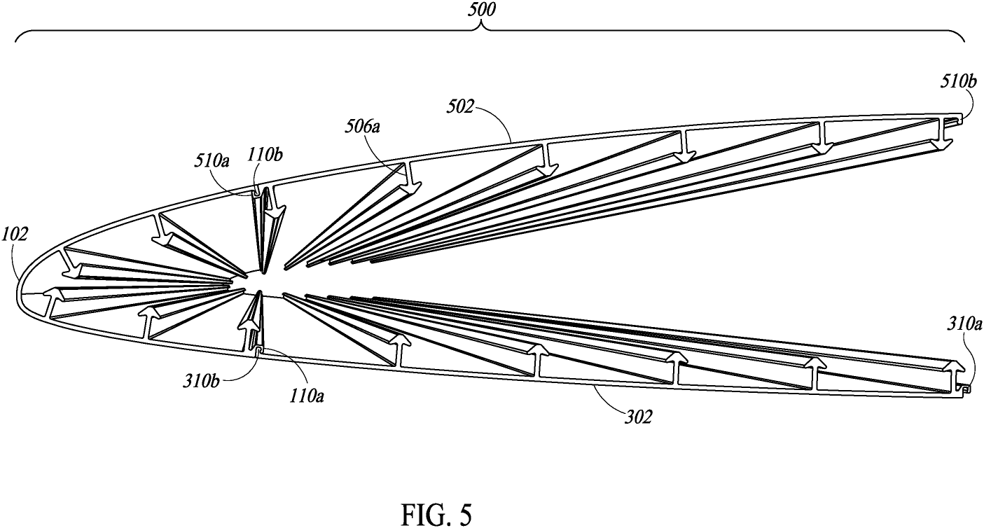

FIG. 5 shows a portion 500 of an assembly of three parts or extrusions in the form of the leading edge extrusion 102, the lower leading edge skin extrusion 302, and an upper leading edge skin extrusion 502, according to at least one illustrated implementation. The upper leading edge skin extrusion 502 includes a skin 104 and a plurality of reinforcement structures or stiffeners, for example in the form of stringers 106a, 106b (only two called out). The lower leading edge skin extrusion 302 and the upper leading edge skin extrusion 502 each include complementary joint portions or features 310a, 310b, 510a, 510b. The lower leading edge skin extrusion 302 and the upper leading edge skin extrusion 502 are each physically coupled or joined to the leading edge extrusion 102 at joints formed via complementary joint portions or features 310a, 310b, 510a, 510b, 110a, 110b to form the portion 500 of an assembly.

The upper leading edge skin extrusion 502 can include one or more retainers or structural features 112 (only one called out in FIG. 4) that are shaped and position to capture and/or hold onto a core (e.g., polymer, open cell or closed cell foam) when inserted and/or expanded and/or cured. The retainers or structural features 112 can, for example, take the form of a head or widen area, for example formed at a distal end of the stringers 106a, 106b.

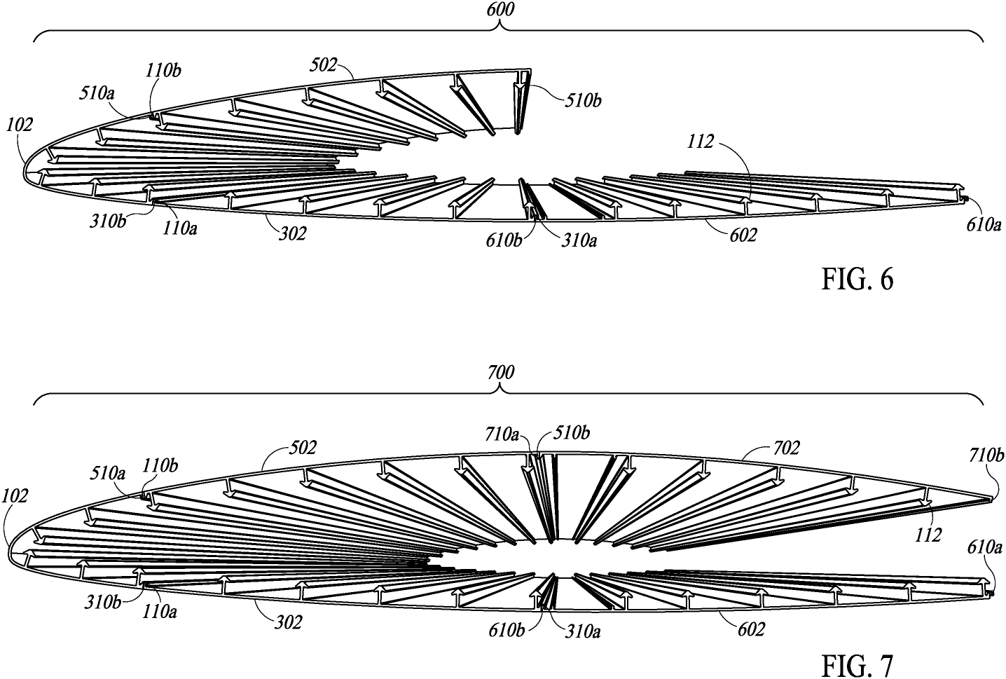

FIG. 6 shows a portion 600 of an assembly of four parts or extrusions in the form of the leading edge extrusion 102, the lower leading edge skin extrusion 302, the upper leading edge skin extrusion 502, and a lower trailing edge skin extrusion 602, according to at least one illustrated implementation. The lower trailing edge skin extrusion 602 includes a skin 104 and a plurality of reinforcement structures or stiffeners, for example in the form of stringers 106a, 106b (only two called out). The leading edge extrusion 102, the lower leading edge skin extrusion 302, the upper leading edge skin extrusion 502, and the lower trailing edge skin extrusion 602 each include complementary joint portions or features 110a, 110b, 310a, 310b, 510a, 510b, 610a, 610b. The lower leading edge skin extrusion 302 and the upper leading edge skin extrusion 502 are each physically coupled or joined to the leading edge extrusion 102 at joints formed via complementary joint portions or features 310a, 10a, 310a, 10b, 510a, 510b, 110a, 110b and the lower trailing edge skin extrusion 602 is physically coupled or joined to the lower leading edge skin extrusion 302 at joints formed via complementary joint portions or features 610a, 610b, 310a, 310b to form the portion 600 of the assembly.

The lower trailing edge extrusion 602 can include one or more retainers or structural features 112 (only one called out in FIG. 6) that are shaped and position to capture and/or hold onto a core (e.g., polymer, open cell or closed cell foam) when inserted and/or expanded and/or cured. The retainers or structural features 112 can, for example, take the form of a head or widen area, for example formed at a distal end of the stringers 106a, 106b.

FIG. 7 shows a portion 700 of an assembly of five parts or extrusions in the form of the leading edge extrusion 102, the lower leading edge skin extrusion 302, the upper leading edge skin extrusion 502, the lower trailing edge skin extrusion 602, and an upper trailing edge skin extrusion 702, according to at least one illustrated implementation. The upper trailing edge skin extrusion 702 includes a skin 104 and a plurality of reinforcement structures or stiffeners, for example in the form of stringers 106a, 106b (only two called out). The leading edge extrusion 102, the lower leading edge skin extrusion 302, the upper leading edge skin extrusion 502, the lower trailing edge skin extrusion 602, and the upper trailing edge skin extrusion 702 each include complementary joint portions or features 110a, 110b, 310a, 310b, 510a, 510b, 610a, 610b, 710a, 710b. The lower leading edge skin extrusion 302 and the upper leading edge skin extrusion 502 are each physically coupled or joined to the leading edge extrusion 102 at joints formed via complementary joint portions or features 310a, 310b, 510a, 510b, 110a, 110b, the lower trailing edge skin extrusion 602 is physically coupled or joined to the lower leading edge skin extrusion 302 at joints formed via complementary joint portions or features 610a, 610b, 310a, 310a, 10b, and the upper trailing edge skin extrusion 702 is physically coupled or joined to the upper leading edge skin extrusion 502 at joints via complementary joint portions or features 710a, 710b, 710a, 710b to form the portion 700 of the assembly.

The upper trailing edge extrusion 702 can include one or more retainers or structural features 112 (only once called out in FIG. 7) that are shaped and position to capture and/or hold onto a core (e.g., polymer, open cell or closed cell foam) when inserted and/or expanded and/or cured. The retainers or structural features 112 can, for example, take the form of a head or widen area, for example formed at a distal end of the stringers 106a, 106b.

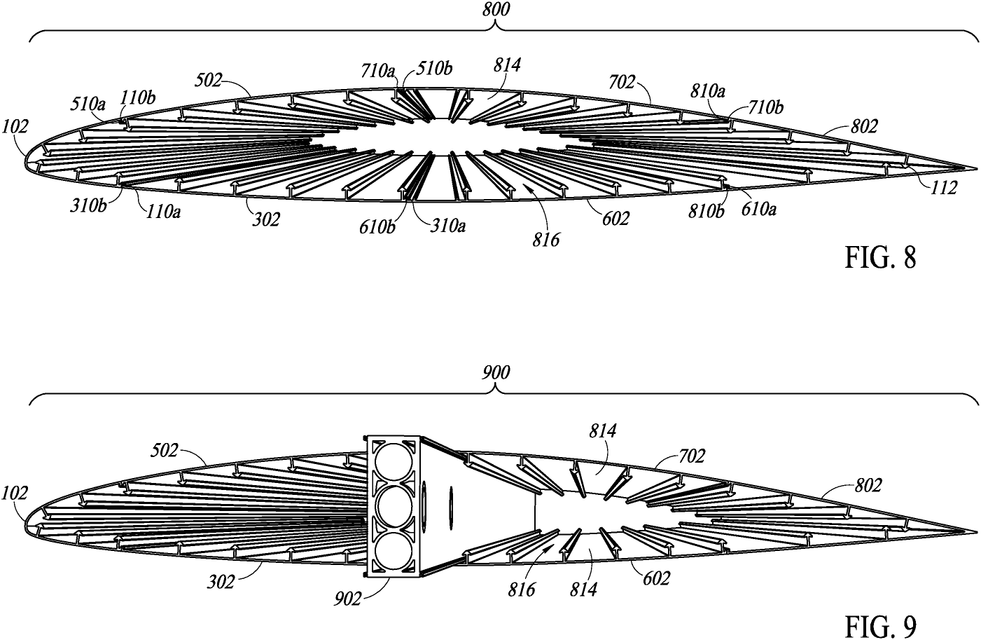

FIG. 8 shows an assembly 800 of six parts or extrusions in the form of the leading edge extrusion 102, the lower leading edge skin extrusion 302, the upper leading edge skin extrusion 502, the lower trailing edge skin extrusion 602, the upper trailing edge skin extrusion 702, and a trailing edge skin extrusion 802, according to at least one illustrated implementation. The trailing edge skin extrusion 302 includes a skin 104 and a plurality of reinforcement structures or stiffeners, for example in the form of stringers 106a, 106b (only two called out). The leading edge extrusion 102, the lower leading edge skin extrusion 302, the upper leading edge skin extrusion 502, the lower trailing edge skin extrusion 602, the upper trailing edge skin extrusion 702, and trailing edge skin extrusion 802 each include complementary joint portions or features 110a, 110b, 310a, 310b, 510a, 510b, 610a, 610b, 710a, 710b, 810a, 810b. The lower leading edge skin extrusion 302 and the upper leading edge skin extrusion 502 are each physically coupled or joined to the leading edge extrusion 102 at joints formed via complementary joint portions or features 310a, 10a, 310a, 10b, 510a, 510b, 110a, 110b, the lower trailing edge skin extrusion 602 is physically coupled or joined to the lower leading edge skin extrusion 302 at joints formed via complementary joint portions or features 610a, 610b, 310a, 310b, the upper trailing edge skin extrusion 702 is physically coupled or joined to the upper leading edge skin extrusion 502 at joints via complementary joint portions or features 710a, 710b, 710a, 710b, and the lower trailing edge skin extrusion 602 and the upper trailing edge skin extrusion 702 are each coupled or jointed to the trailing edge skin extrusion 802 via complementary joint portions or features 610a, 610b, 710a, 710b, 810a, 810b to form the assembly 800.

The trailing edge extrusion 802 can include one or more retainers or structural features 112 (only one called out in FIG. 8) that are shaped and position to capture and/or hold onto a core (e.g., polymer, open cell or closed cell foam) when inserted and/or expanded and/or cured. The retainers or structural features 112 can, for example, take the form of a head or widen area, for example formed at a distal end of the stringers 106a, 106b.

Notably, the assembly 800 has a closed surface 814 (at least when viewed in profile) formed by the skin, with an interior or cavity 816 delineated by the closed surface of the assembly. The assembly 800 can be open at one or both ends 818 of the closed surface 814.

FIGS. 9 and 10 show an assembled structure 900 formed by the assembly 800 of FIG. 8 with a main support structure added, in the form of a main spar 902, according to at least one illustrated implementation. The main spar 902 can, for example, extend outwardly from the interior or cavity 816 of the assembly 800 of FIG. 8, according to at least one illustrated implementation. The main spar 902 may or may not be an extrusion.

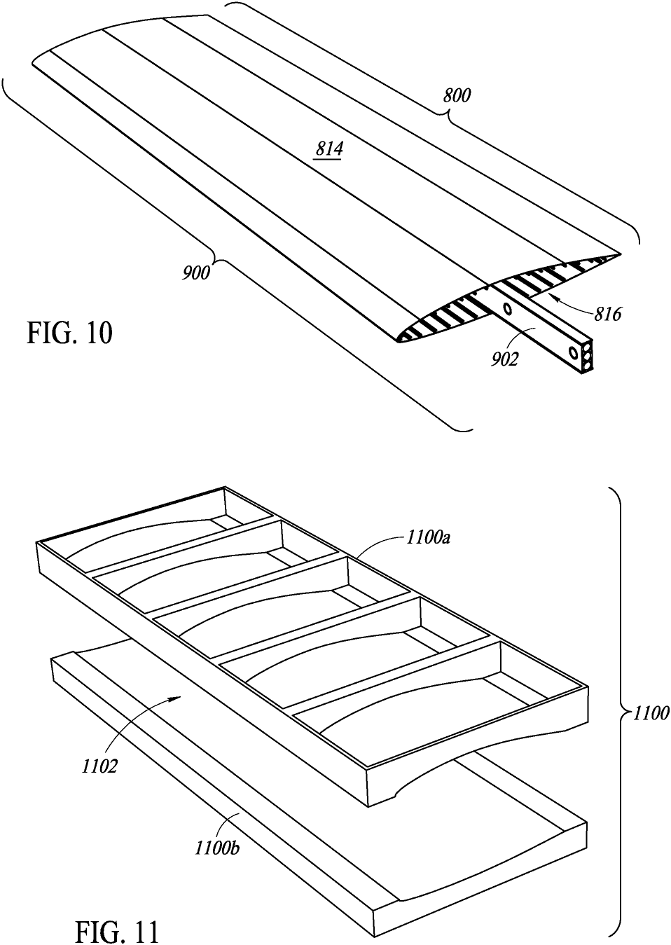

FIG. 11 shows a mold 1100 according to at least one illustrated implementation. The mold 1100 can have two or more portions 1100a, 1100b (two shown) and a mold cavity 1102 with an inner surface, the mold cavity 1102 sized to be employed in manufacturing a structure comprising one or more extrusions, for example employing the assembled structure 900 of FIGS. 9 and 10. The portions 1100a, 1100b may, for example be separable from one another to allow the assembled structure 900 to be positioned into the mold cavity, then the portions 1100a, 1100b fastened to one another to prevent movement of the assembled structure 900. One end of the mold 1100 can be sealed, while the other end has at least one aperture or opening to allow the ingress of a fluid or colloidal suspension (e.g., core material in fluid or colloidal suspension form).

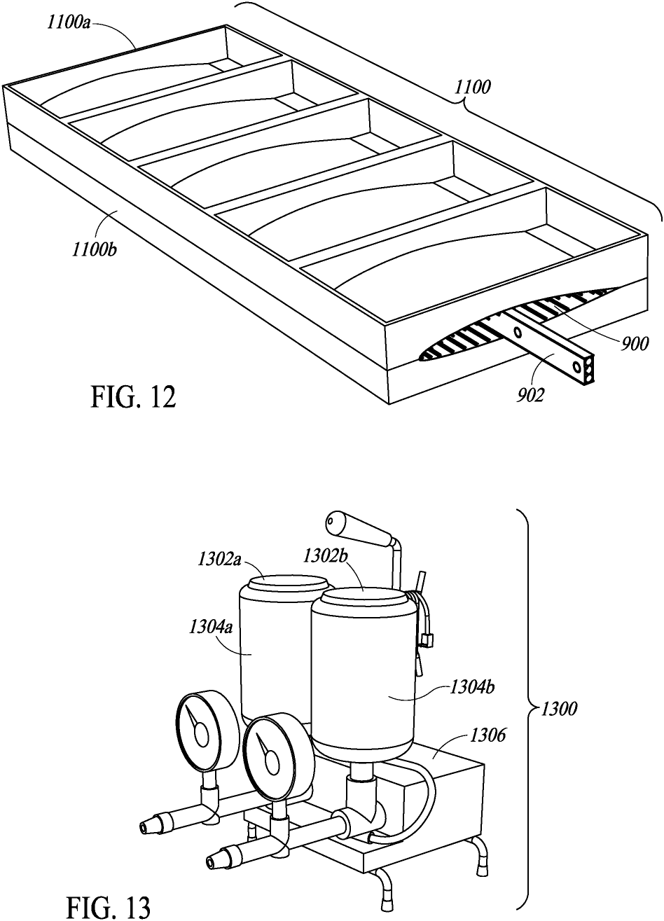

FIG. 12 shows the mold of FIG. 11 with the assembled structure 900 (FIGS. 9 and 10) inserted or received in the mold cavity 1102 of the mold 1100, according to at least one illustrated implementation. The mold 1100 retains the various parts or extrusions (e.g., 102, 302, 502, 602, 702, 802) in a relatively fixed relationship, particularly as a core is provided or formed in the interior of the assembly 800 or assembled structure 900, as explained herein.

FIG. 13 shows an injection system 1300 operable to inject core material into the cavity of the mold of FIG. 11 and into an interior of the structure of FIG. 10 while the structure is received in the cavity of the mold, according to at least one illustrated implementation. The injection system 1300 may include one or more reservoirs 1302a, 1302b (two shown) that contain one or more materials 1304a, 1304b (e.g., one material for each of two or more reservoirs). The core material may for example take the form of a polymer, an epoxy, or preferably a lightweight per volume foam, for example an open cell or closed cell foam (e.g., polyurethane foam, isocyanate and polyol resin, foam rubber). The core material is preferably flowable, at least under pressure, for example from a pump 1306, and is preferably self-expandable or expandable under pressure once injected to a cavity (e.g., interior or cavity 816 of assembly 800, and/or mold cavity 1102).

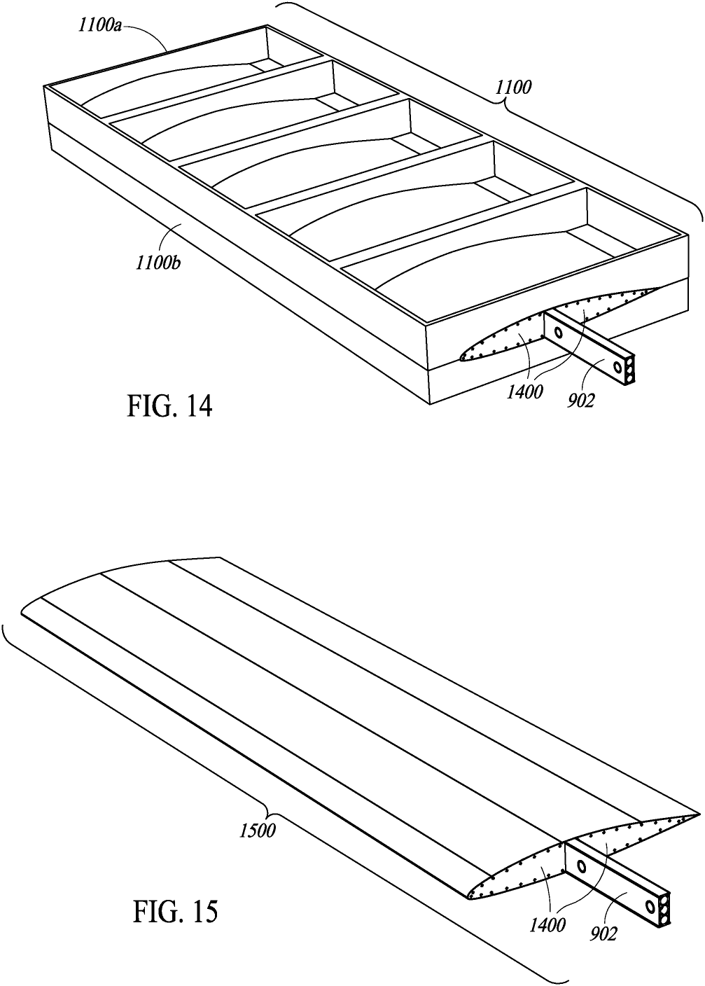

FIG. 14 shows the mold 1100 with the assembled structure 900 (FIGS. 9 and 10) received in the cavity 1102 of the mold 1100 and a core in the form of an expanded foam core 1400 injected into the interior or cavity 816 of the assembly 800 or the assembled structure 900 (FIGS. 9 and 10), according to at least one illustrated implementation.

The core material can advantageously be self-expandable or expandable under pressure when injected or otherwise provided into a cavity, for example taking the form of an expandable foam which advantageously has a low weight to volume ratio. Various open cell or closed cell foams can be employed, for instance polyurethane foam. The expansion of the core material can apply a radially outward force the parts or extrusions, which parts or extrusions are physically constrained in place by the inner surface of the cavity of the mold and/or by the various joints. In at least some implementations, the radially outwardly applied force can cause the outer surface of the assembled structure 900 to conform to the inner surface of the cavity 1102 of the mold 1100, and thus may closely resemble at least in overall shape the inner surface of the cavity 1102 of the mold 1100.

In at least some implementations, the core material may be allowed to harden or cure, for example naturally when exposed to air over a sufficient time period, or in response to a stimulus (e.g., exposure to selected wavelengths of electromagnetic energy for instance ultraviolet light), or in response to a chemical reaction between two or more chemicals (e.g., two-part epoxy), or in a combination of the aforesaid. Once hardened or cured, the resulting structure 1500

FIG. 15 shows a resulting structure 1500, also denominated as a finished structure, removed from the mold 1100 (FIG. 11), comprising the assembled structure 900 (FIGS. 9 and 10) formed from the assembly 800 (FIG. 8) with the main spar 902 and the expanded foam core 1400 (FIG. 14), according to at least one illustrated implementation. In the resulting structure 1500 the expanded foam core 1400 (FIG. 14) may be hardened or cured as discussed above. The parts or extrusions of the resulting structure 1500 are securely bound together via the complementary joint portions or features 110a, 110b and the expanded foam core 1400 (FIG. 14), and/or via the physical interaction of the retainers or structural features 112 with the expanded foam core 1400. The expanded foam core 1400 provides added structural rigidity while adding little weight to the overall structure 1500. In at least some implementations, when the expanded foam core 1400 (FIG. 14) is hardened or cured, the resulting structure 1500 cannot be disassembled without destruction of one or more portions (e.g., destruction of the expanded foam core 1400).

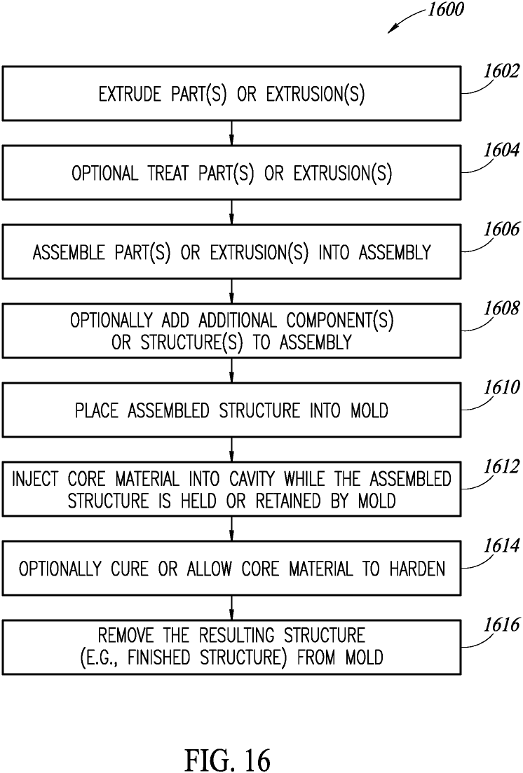

FIG. 16 shows a method 1600 of manufacturing, according to at least one illustrated implementation.

At 1602, one or more extruders extrude one or more parts or extrusions.

Optionally at 1604, one or more parts or extrusions are treated. For example, one or more parts or extrusions may be anodized, painted, powder coated using conventional techniques. Treatment can alternatively or additionally occur after the parts or extrusions are assembled into an assembly.

At 1606, the parts or extrusions are assembled into an assembly. For example, the parts may be physically coupled to one another (e.g., physically coupled to immediately adjacent parts or extrusions) via one or more joint portions or features, which can be integral to the respective part or extrusion.

Optionally at 1608, one or more additional components (e.g., main spar) or structures can be added to the assembly.

At 1610, the assembled structure is placed into a mold.

At 1612, core material is injected into a cavity in assembled structure while the assembled structure is held or retained by the mold.

Optionally at 1614, core material is cured or allowed to harden into a cured or hardened core.

At 1616, the resulting structure (e.g., finished structure) is removed from mold.

### EXAMPLES

Example 1. A method of manufacturing, comprising:
assembling two or more parts or extrusions into an assembly;
placing the assembly into a mold;
injecting a core material into an interior or cavity of the assembly while the assembly is retained in the mold; and
removing a resulting structure from the mold.

Example 2. The method of example 1, further comprising: extruding the two or more parts or extrusions before assembling the two or more parts or extrusions into the assembly.

Example 3. The method of example 1, further comprising: extruding the two or more parts or extrusions as metal extrusions before assembling the two or more parts or extrusions into the assembly.

Example 4. The method of example 1, further comprising: extruding the two or more parts or extrusions as plastic extrusions before assembling the two or more parts or extrusions into the assembly.

Example 5. The method of example 1 wherein assembling two or more parts or extrusions into an assembly comprises assembling two or more extrusions into the assembly.

Example 6. The method of example 1 wherein assembling two or more parts or extrusions into an assembly comprises assembling at least one stamped part and at least one other part or extrusion into the assembly.

Example 7. The method of any of examples 2 through 6, further comprising: treating at least one of the two or more parts or extrusions before assembling two or more parts or extrusions into the assembly.

Example 8. The method of any of examples 2 through 6, further comprising: treating at least one of the two or more parts or extrusions after assembling two or more parts or extrusions into the assembly.

Example 9. The method of any of examples 1 through 8, further comprising: adding one or more additional components (e.g., main spar) or structures to the assembly before placing the assembly into the mold.

Example 10. The method of any of examples 1 through 9, further comprising: adding one or more additional components (e.g., main spar) or structures to the assembly after placing the assembly into the mold.

Example 11. The method of any of examples 1 through 10, further comprising: curing or hardening the core material into a cured or hardened core.

Example 12. The method of any of examples 1 through 11, further comprising: curing or hardening the core material into a cured or hardened core before removing the resulting structure from the mold.

Example 13. The method of any of examples 1 through 12 wherein assembling two or more parts or extrusions into the assembly comprises: physically coupled adjacent ones of the two or more parts to one another via one or more joint portions or features which are integral to the respective part or extrusion.

Example 14. The method of any of examples 1 through 13 wherein injecting a core material into an interior or cavity of the assembly while the assembly is retained in the mold comprises injecting an expandable foam into the interior or cavity of the assembly while the assembly is retained in the mold.

Example 15. An article of manufacture, comprising:
an assembly of two or more parts or extrusions having an interior or cavity therein;
placing the assembly into a mold; and
a core of a cured or hardened core material in the interior or cavity of the assembly that provides structural rigidity to the assembly.

Example 16. The article of manufacture of example 15 wherein the cured or hardened a core material is an expandable foam material that has been allowed to hardened or cured.

Example 17. The article of manufacture of any of examples 15 or 16 wherein the two or more parts or extrusions each include one or more joint portions or features that complementary physically coupled to one or more joint portions or features of another one of the two or more parts or extrusions.

Example 18. The article of manufacture of example 17 wherein the one or more joint portions or features are integral to the two or more parts or extrusions.

Example 19. The article of manufacture of any of examples 15 through 18 wherein each of the two or more parts or extrusions includes a skin portion and the one or more joint portions or features are integral to skin portions of the two or more parts or extrusions.

Example 20. The article of manufacture of any of examples 15 through 19 wherein each of the two or more parts or extrusions includes a skin portion and a number of reinforcement structures or stiffeners, that are integral to the skin portion of the two or more parts or extrusions.

Example 21. The article of manufacture of example 17 wherein the reinforcement structures or stiffeners are stringers.

Example 22. The article of manufacture of any of examples 15 through 21 wherein each of the two or more parts or extrusions includes a skin portion and a number of retainers or structural features that are shaped and positioned to capture and/or hold onto the core.

23. The article of manufacture of any of examples 15 through 22 wherein each of the two or more parts or extrusions includes a skin portion, a number of reinforcement structures or stiffeners, and a number of retainers or structural features that are shaped and position to capture and/or hold onto the core, the retainers or structural features integral to respective ones of the reinforcement structures or stiffeners.

Example 24. The article of manufacture of any of examples 15 through 23 wherein at least one of the two or more parts or extrusions is a metal part or a metal extrusion.

Example 25. The article of manufacture of any of examples 15 through 23 wherein at least one of the two or more parts or extrusions is a plastic part or a plastic extrusion.

Example 26. The article of manufacture of any of examples 15 through 23 wherein at least one of the two or more parts or extrusions is a stamped part.

Example 27. The article of manufacture of any of examples 15 through 26 wherein article of manufacture is a component of an airframe.

Example 28. The article of manufacture of any of examples 15 through 26 wherein article of manufacture is a component of a vehicle.

Example 29. The article of manufacture of any of examples 15 through 26 wherein article of manufacture is a component of a building.

Example 30. The article of manufacture of any of examples 15 through 26 wherein article of manufacture is a component of a storage container or an intermodal shipping container.

Example 31. A method of manufacture as illustrated and described herein.

Example 32. An article of manufacture as illustrated and described herein.

The various embodiments described above can be combined to provide further embodiments. These and other changes can be made to the embodiments in light of the above-detailed description. All of the commonly assigned US patent application publications, US patent applications, foreign patents, and foreign patent applications referred to in this specification and/or listed in the Application Data Sheet, including but not limited to International Patent Application PCT/US2019/055687, published as WO 2020/077121; U.S. Provisional Pat. Application No. 63/178,948, filed Apr. 23, 2021; and U.S. Provisional Pat. Application No. 63/220,696, filed Jul. 12, 2021, are incorporated herein by reference in their entirety. In general, in the following claims, the terms used should not be construed to limit the claims to the specific implementations or embodiments disclosed in the specification and the claims, but should be construed to include all possible implementations or embodiments along with the full scope of equivalents to which such claims are entitled. Accordingly, the claims are not limited by the disclosure.

I/We claim:

1. A method of manufacturing, comprising:
assembling two or more parts or extrusions into an assembly;
placing the assembly into a mold;
injecting a core material into an interior or cavity of the assembly while the assembly is retained in the mold; and
removing a resulting structure from the mold.

2. The method of claim 1, further comprising:
extruding the two or more parts or extrusions before assembling the two or more parts or extrusions into the assembly.

3. The method of claim 1, further comprising:
extruding the two or more parts or extrusions as metal extrusions before assembling the two or more parts or extrusions into the assembly.

4. The method of claim 1, further comprising:
extruding the two or more parts or extrusions as plastic extrusions before assembling the two or more parts or extrusions into the assembly.

5. The method of claim 1 wherein assembling two or more parts or extrusions into an assembly comprises assembling two or more extrusions into the assembly.

6. The method of claim 1 wherein assembling two or more parts or extrusions into an assembly comprises assembling at least one stamped part and at least one other part or extrusion into the assembly.

7. The method of claim 1, further comprising:
treating at least one of the two or more parts or extrusions before assembling two or more parts or extrusions into the assembly.

8. The method of claim 1, further comprising:
treating at least one of the two or more parts or extrusions after assembling two or more parts or extrusions into the assembly.

9. The method of claim 1, further comprising:
adding one or more additional components or structures to the assembly before placing the assembly into the mold.

10. The method of claim 1, further comprising:
adding one or more additional components or structures to the assembly after placing the assembly into the mold.

11. The method of claim 1, further comprising:
curing or hardening the core material into a cured or hardened core.

12. The method of claim 1, further comprising:
curing or hardening the core material into a cured or hardened core before removing the resulting structure from the mold.

13. The method of claim 1 wherein assembling two or more parts or extrusions into the assembly comprises: physically coupled adjacent ones of the two or more parts to one another via one or more joint portions or features which are integral to the respective part or extrusion.

14. The method of claim 1 wherein injecting a core material into an interior or cavity of the assembly while the assembly is retained in the mold comprises injecting an expandable foam into the interior or cavity of the assembly while the assembly is retained in the mold.

15. An article of manufacture, comprising:
an assembly of two or more parts or extrusions having an interior or cavity therein;
placing the assembly into a mold; and
a core of a cured or hardened core material in the interior or cavity of the assembly that provides structural rigidity to the assembly.

16. The article of manufacture of claim 15 wherein the cured or hardened a core material is an expandable foam material that has been allowed to hardened or cured.

17. The article of manufacture of claim 15 wherein the two or more parts or extrusions each include one or more joint portions or features that complementary physically coupled to one or more joint portions or features of another one of the two or more parts or extrusions.

18. The article of manufacture of claim 17 wherein the one or more joint portions or features are integral to the two or more parts or extrusions.

19. The article of manufacture of claim 15 wherein each of the two or more parts or extrusions includes a skin portion and the one or more joint portions or features are integral to skin portions of the two or more parts or extrusions.

20. The article of manufacture of claim 15 wherein each of the two or more parts or extrusions includes a skin portion and a number of reinforcement structures or stiffeners, that are integral to the skin portion of the two or more parts or extrusions.

21. The article of manufacture of claim 17 wherein the reinforcement structures or stiffeners are stringers.

22. The article of manufacture of claim 15 wherein each of the two or more parts or extrusions includes a skin portion and a number of retainers or structural features that are shaped and positioned to capture and/or hold onto the core.

23. The article of manufacture of claim 15 wherein each of the two or more parts or extrusions includes a skin portion, a number of reinforcement structures or stiffeners, and a number of retainers or structural features that are shaped and position to capture and/or hold onto the core, the retainers or structural features integral to respective ones of the reinforcement structures or stiffeners.

24. The article of manufacture of claim 15 wherein at least one of the two or more parts or extrusions is a metal part or a metal extrusion.

25. The article of manufacture of claim 15 wherein at least one of the two or more parts or extrusions is a plastic part or a plastic extrusion.

26. The article of manufacture of claim 15 wherein at least one of the two or more parts or extrusions is a stamped part.

27. The article of manufacture of claim 15 wherein article of manufacture is a component of an airframe, a vehicle, a building, a storage container or an intermodal shipping container.
